(19) United States
(12) Patent Application Publication
(10) Pub. No.: US 2026/0369510 A1
(43) Pub. Date: Nov. 19, 2026

(54) FUSE ENDBELL STRUCTURE

(71) Applicant: Littelfuse, Inc., Rosemont, IL (US)

(72) Inventors: Ganesh Chennakesavelu, Rolling Meadows, IL (US); Engelbert Hetzmannseder, Klosterneuburg (AT); Joselito Pino, Des Plaines, IL (US)

(73) Assignee: Littelfuse, Inc., Rosemont, IL (US)

(21) Appl. No.: 19/677,006

(22) Filed: May 14, 2026

(30) Foreign Application Priority Data
May 15, 2025 (CN) 202510629242.5

(51) Int. Cl. H01H 85/143; H01H 85/055

(52) U.S. Cl. CPC H01H 85/143; H01H 85/055

(57) ABSTRACT

A fuse assembly and methods of manufacturing thereof. The fuse assembly includes a fuse body, and a fuse element at least partially disposed within an interior of the fuse body. The fuse element includes one or more fuse terminals protruding exterior to the fuse body. The fuse assembly also includes an endbell configured to be coupled to the fuse body. The endbell has an exterior endbell surface and an interior endbell surface. The interior endbell surface is disposed in the interior of the fuse body. The endbell has an actuatable component disposed on the exterior endbell surface and along at least a portion of an outer perimeter of the exterior endbell surface. The actuatable component is configured be actuated upon occurrence of an actuation condition to seal an interior of the fuse body.

### CROSS-REFERENCE TO RELATED APPLICATIONS

This application claims the benefit of and priority to Chinese Patent Application No. 202510629242.5, filed May 15, 2025, entitled “FUSE ENDBELL STRUCTURE”, the disclosure of which is incorporated herein by reference in its entirety.

### TECHNICAL FIELD

This disclosure relates generally to the field of circuit protection devices, and in particular, to fuses, and even more particularly, to endbell structures of fuses.

### BACKGROUND

Fuses are used in electrical systems to protect against excessive current and break when an overcurrent condition occurs. Fuses have many applications, e.g., from small circuit electronics to large-scale industrial applications. They can be used as protection devices as well as safety devices, such as, for example, when used in vehicles to protect against fires in response to vehicle accidents. Fuses come in a variety of sizes, shapes, and may have different structural features and operational characteristics. Typically, fuses include a fuse body that encases a fuse element, e.g., a metal wire or strip (e.g., silver, copper, etc.), that links two metal contact terminals together and that melts/breaks if too much current flows through the fuse. The terminals are connected to circuit elements that the fuse is designed to protect. The breakage of the metal strip creates an open circuit, thereby disconnecting these circuit elements, thereby protecting the same.

Some fuses may include endbells at either side of the fuse body. The endbells are designed to support and protect the fuse element from external forces and environmental stresses. The endbells are secured at each end of the fuse body to seal interior of the fuse body. The endbells, such as those, used in sand-filled fuses, may also be designed to prevent leakage of internal contents of the fuse, which, in case of the sand-filled fuse, includes sand particles. The sand particles may include high-purity silica sand and/or quartz sand. The sand surrounds the fuse element. Upon occurrence of, for example, an overcurrent condition, the arc created by the heating and melting of the fuse element is quenched and extinguished by the sand contained within the fuse body. While the sand-filled fuses are generally reliable, the fuse's endbells sometimes allow leakage of sand from the fuse body, thereby reducing effectiveness of the fuse or, worse, causing a catastrophic failure of the fuse, thereby damaging the circuit components coupled to the fuse.

### SUMMARY

The following summary is provided to introduce a selection of concepts in a simplified form that are further described below in the detailed description. This summary is not intended to identify key or essential features of the claimed subject matter, nor is it intended as an aid in determining the scope of the claimed subject matter.

In some implementations, the current subject matter relates to a fuse assembly. The fuse assembly may include a fuse body, a fuse element at least partially disposed within an interior of the fuse body, the fuse element may include one or more fuse terminals protruding exterior to the fuse body, and an endbell configured to be coupled to the fuse body, the endbell may have an exterior endbell surface and an interior endbell surface, the interior endbell surface may be disposed in the interior of the fuse body. The endbell may have an actuatable component disposed on the exterior endbell surface and along at least a portion of an outer perimeter of the exterior endbell surface. The actuatable component may be configured be actuated upon occurrence of an actuation condition to seal an interior of the fuse body.

In some implementations, the current subject matter may include one or more optional features. The actuatable component may include a protrusion extending from the exterior endbell surface and away from the interior of the fuse body, where prior to occurrence of the actuation condition, the protrusion does not contact the fuse body. Upon occurrence of the actuation condition, the protrusion may be configured to fold and contact the fuse body, thereby sealing the interior of the fuse body.

In some implementations, the endbell may be a unitary endbell that may have an endbell terminal opening. The one or more fuse terminals may be configured to protrude through the endbell terminal opening.

In some implementations, the endbell may include a first endbell portion and a second endbell portion. The first endbell portion may be configured to be coupled to the second endbell portion forming the endbell. One or more terminals may be configured to be coupled to and sandwiched between the first endbell portion and the second endbell portion.

In some implementations, the fuse body may include one or more fuse body openings. One or more fuse body openings may be configured to be aligned with one or more endbell openings. One or more endbell openings may be disposed between the exterior endbell surface and the interior endbell surface. One or more fuse body openings and one or more endbell openings may be configured to receive one or more pins to secure the endbell to the fuse body.

In some implementations, the interior endbell surface may include an interior protrusion extending away from the interior endbell surface. The interior protrusion may be configured to be disposed along at least a portion of an outer perimeter of the interior endbell surface. The interior protrusion may be configured to be positioned adjacent an interior surface of the interior of the fuse body upon coupling of the fuse body and the endbell.

In some implementations, at least a portion of an interior surface of the fuse body may include a chamfer. Upon occurrence of the actuation condition, the protrusion may be configured to fold and cover the chamfer.

In some implementations, one or more fuse terminals may include a first terminal and a second terminal. The first terminal may be configured to protrude exterior to a first end of the fuse body and the second terminal may be configured to protrude exterior to a second end of the fuse body. The interior of the fuse body may be a hollow interior configured to be filled with an electrical arc quenching substance. The electrical arc quenching substance may include at least one of the following: a quartz sand, a high-purity silica sand, sand, or any combination thereof, wherein the electrical arc quenching substance is configured to extinguish an electrical arc caused by an overcurrent condition characterized by a current causing a portion of the fuse element disposed between the first and second terminals to melt and generate the electrical arc. The actuation condition may include coupling of the endbell to the fuse body.

In some implementations, the endbell may be formed from a zinc alloy.

In some implementations, the current subject matter relates to an endbell for coupling to a fuse body of a fuse, the fuse may include a fuse element at least partially disposed within an interior of the fuse body, the fuse element may include one or more fuse terminals protruding exterior to the fuse body. The endbell may include an endbell body that may have an exterior endbell surface and an interior endbell surface. The interior endbell surface may be configured to be disposed in the interior of the fuse body upon coupling of the endbell and the fuse body. The endbell may include an actuatable component disposed on the exterior endbell surface and along at least a portion of an outer perimeter of the exterior endbell surface. The actuatable component may be configured be actuated upon occurrence of an actuation condition to seal an interior of the fuse body.

In some implementations, the current subject matter may include one or more of the following optional features. The actuatable component may include a protrusion extending from the exterior endbell surface and away from the interior of the fuse body, where prior to occurrence of the actuation condition, the protrusion does not contact the fuse body. Upon occurrence of the actuation condition, the protrusion may be configured to fold and contact the fuse body, thereby sealing the interior of the fuse body.

In some implementations, the interior endbell surface may include an interior protrusion extending away from the interior endbell surface. The interior protrusion may be configured to be disposed along at least a portion of an outer perimeter of the interior endbell surface. The interior protrusion may be configured to be positioned adjacent an interior surface of the interior of the fuse body upon coupling of the fuse body and the endbell.

In some implementations, the endbell body may be formed from a zinc alloy.

In some implementations, at least a portion of an interior surface of the fuse body may include a chamfer. Upon occurrence of the actuation condition, the protrusion may be configured to fold and cover the chamfer.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 illustrates an example fuse assembly, according to some implementations of the current subject matter;

FIGS. 2A-B illustrate further details of the fuse assembly shown in FIG. 1, according to some implementations of the current subject matter;

FIGS. 3A-B illustrate further details the fuse assembly, according to some implementations of the current subject matter;

FIG. 4 illustrates additional details the fuse assembly, according to some implementations of the current subject matter.

FIGS. 5A-D illustrate details of the endbell, according to some implementations of the current subject matter; and

FIGS. 6A-B illustrate an example of the endbell, according to some implementations of the current subject matter.

### DETAILED DESCRIPTION

Various approaches in accordance with the present disclosure will now be described more fully hereinafter with reference to the accompanying drawings, where implementations of a system and method are shown. The devices, system(s), component(s), etc., may be embodied in many different forms and are not to be construed as being limited to the example implementations set forth herein. Instead, these example implementations are provided so this disclosure will be thorough and complete, and will fully convey the scope of the current subject matter to those skilled in the art.

To address these and potentially other deficiencies of currently available solutions, one or more implementations of the current subject matter relate to methods, systems, articles of manufacture, and the like that can, among other possible advantages, provide for a fuse assembly that may include an endbell assembly configured to prevent leakage of an electrical arc quenching substance (e.g., sand) from the interior of the fuse.

In some implementations, the current subject matter relates to a fuse assembly that may include a fuse body and a fuse element. The fuse body may have a cylindrical shape and/or any other desired shape. The fuse body may also have a hollow interior that may be open at one or both ends. For example, the fuse body may be a hollow cylinder that may be configured to house at least a portion of the fuse element along with an electrical arc quenching substance. The electrical arc quenching substance may include at least one of the following: a quartz sand, a high-purity silica sand, sand, and/or any other substance, and/or any combination thereof. The electrical arc quenching substance may be configured to quench an electrical arc that may occur when the fuse element, which may be coupled to one or more circuit elements that the fuse assembly may be designed to protect, receives current that may have a value above a predetermined threshold. Such current may cause the fuse element to heat up and melt, thereby creating the electrical arc. The electrical arc quenching substance may be configured to quench and/or extinguish the electrical arc.

The fuse element may include one or more fuse terminals, e.g., a first terminal and a second terminal. The fuse terminals may be configured to protrude exterior to the fuse body. For example, the first terminal may be configured to protrude exterior to a first end of the fuse body and the second terminal may be configured to protrude exterior to a second end of the fuse body. The terminals may be electrically coupled to one or more circuit elements that the fuse assembly may be used to protect from overcurrent conditions and/or excessive current conditions.

The fuse assembly may also include one or more endbells. The endbell(s) may, for example, be formed from a zinc alloy and/or any other desired material. The endbells may be coupled to at each end of the fuse body and may be configured to serve as covers for the open ends of the fuse body as well as to secure the fuse element terminals. By covering the open ends of the fuse body, the endbells may be configured to prevent the electrical arc quenching substance from leaking and/or spilling out from the interior of the fuse body. One or more endbells may be used. For example, a first endbell may be coupled at the first end of the fuse body and a second endbell may be coupled at the second end of the fuse body. Alternatively, or in addition, the fuse assembly may include a single endbell that may be coupled at the first end of the fuse body, while the second end of the fuse body may be enclosed (e.g., the fuse body may be configured to have one open end).

The endbells may include an endbell body disposed between an exterior endbell surface and an interior endbell surface. The endbell body may have an outer dimension, which, for example, in case of a cylindrical fuse body and hence, cylindrical endbell, an outer diameter (OD), that may be substantially the same, larger and/or smaller than an interior dimension of the interior surface of the fuse body (e.g., an inner diameter (ID)). The values of the endbell's outer dimension(s) and/or fuse body's interior's inner dimension(s) may be configured as desired, such as to ensure that that the electrical arc quenching substance does not leak or seep through spaces between the endbell and the fuse body.

The interior endbell surface may be disposed in and face the interior of the fuse body upon coupling of the endbell to the fuse body. The exterior endbell surface may be configured to face exterior to the interior of the fuse body. The endbell may also include an actuatable component (e.g., a crush rib) that may be disposed on the exterior endbell surface and along at least a portion of an outer perimeter of the exterior endbell surface. For example, in case of the cylindrical fuse body, the endbell may be configured to have a circular shape, where the actuatable component may be disposed along an outer circumference of the exterior endbell surface. The actuatable component may be configured be actuated (e.g., crushed, folded, etc.) upon occurrence of the actuation condition. The actuation condition may include coupling of the endbell to the fuse body. Once the actuation condition occurs, the actuatable component may be configured to be crushed, folded, thereby sealing the interior of the fuse body and hence, preventing leakage or seepage of the electrical arc quenching substance from the interior of the fuse body. The actuation condition may also include rolling the endbell (e.g., once coupled to the fuse body), thereby deforming the actuatable component (e.g., a crush rib).

In some implementations, the actuatable component may include a protrusion (e.g., as stated above, a crush rib) that may extend from the exterior endbell surface and away from the interior of the fuse body. Prior to occurrence of the actuation condition, the actuatable component does not contact the fuse body, and once the actuation condition occurs, the actuatable component may be configured to fold and/or crushed in a direction that may be away from the center of the exterior endbell surface and come in contact with the fuse body, thereby sealing the interior of the fuse body.

In some implementations, the endbell may be a unitary endbell. The unitary endbell may include an endbell terminal opening that may allow for the fuse terminal(s) to protrude through the endbell terminal opening. Alternatively, or in addition, the endbell may be composed of two or more parts, e.g., a first endbell portion and a second endbell portion. The first endbell portion may be configured to be coupled to the second endbell portion thereby forming the endbell. The fuse assembly's terminals may be configured to be coupled to and sandwiched between the first endbell portion and the second endbell portion.

To secure the endbell to the fuse body, the endbell and the fuse body may include one or more openings that may be aligned upon coupling of the endbell to the fuse body. For instance, the fuse body may include one or more fuse body openings and the endbell may include one or more endbell openings. Upon installation of the endbell to the fuse body, the fuse body opening(s) may be configured to be aligned with respective endbell opening(s). The endbell opening(s) may be disposed between the exterior endbell surface and the interior endbell surface, e.g., on an outer perimeter of the endbell body. The fuse body opening(s) and the endbell opening(s) may be configured to receive one or more pins, screws, bolts, etc. to secure the endbell to the fuse body.

In some alternate and/or additional embodiments, the interior endbell surface may include an interior protrusion that may extend away from the interior endbell surface (e.g., perpendicular to the interior endbell surface). Such interior protrusion may be configured to be disposed along at least a portion of an outer perimeter of the interior endbell surface. Moreover, the interior protrusion may be configured to be positioned adjacent an interior surface of the interior of the fuse body upon coupling of the fuse body and the endbell. The interior protrusion may also be configured to be used for preventing leakage and/or seepage of the electrical arc quenching substance from the interior of the fuse body.

In some embodiments, at least a portion of the interior surface of the fuse body may include a chamfer. The chamfer (e.g., 45-degree chamfer) may be positioned on the interior surface of the fuse and proximate to first and/or second end of the fuse body. Presence of the chamfer may assist during installation of the endbell into the fuse body. Upon occurrence of the actuation condition (e.g., installation of the endbell into the fuse body), the protrusion disposed on the endbell may be configured to fold and cover the chamfer. The covering of the chamfer by the protrusion may further ensure that leakage and/or seepage of the electrical arc quenching substance from the interior of the fuse body is prevented.

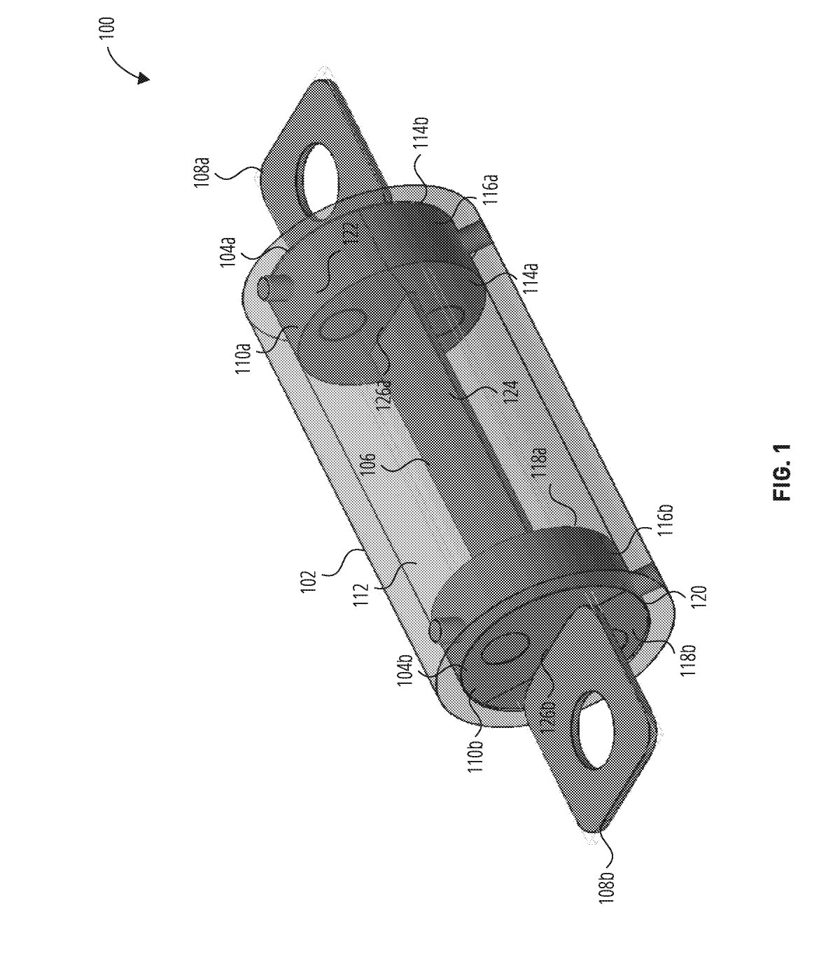

FIG. 1 illustrates an example fuse assembly 100, according to some implementations of the current subject matter. The fuse assembly 100 may include a fuse body 102 having a fuse body opening 104a and fuse body opening 104b, a fuse element 106, and one or more endbells 110a, 110b.

The fuse body 102 may have a cylindrical shape and/or any other desired shapes. The fuse body opening 104a and fuse body opening 104b may be disposed at opposite ends of the fuse body 102. Alternatively, or in addition, the fuse body 102 may include a single fuse body opening 104a, whereas the other fuse body opening 104b may be sealed using the material of the fuse body 102 (e.g., ceramic, glass, etc.). As can be understood, the fuse body 102 may include any number of openings 104a, 104b. The fuse body openings 104a, 104b may likewise be cylindrical and/or any other desired shapes. The openings 104a, 104b may allow access to the fuse interior 112 of the fuse body 102, such as, for example, for positioning the fuse element 106 and an electrical arc quenching substance (e.g., high-purity silica sand, sand, quartz sand, and/or any other substance, material, etc.).

The fuse element 106 may include one or more fuse terminals, such as, for example, a fuse terminal 108a and a fuse terminal 108b. The fuse terminals 108a, 108b may be connected using a fuse connector 124 that may be configured to extend through the fuse interior 112. The fuse terminals 108a, 108b may be configured to be electrically coupled to one or more circuit elements (not shown in FIG. 1) that the fuse assembly 100 may be configured to protect from overcurrent and/or excessive current conditions, which may be defined by current values that may exceed a predetermined current value for which the fuse assembly 100 is rated. For example, upon experiencing such condition, the current passing through the fuse element 106 may be configured to melt the fuse connector 124. Upon melting the fuse connector 124, an electrical arc may be created inside the fuse body 102. The electrical arc quenching substance may then be used to quench and/or extinguish the electrical arc, thereby creating an open circuit and/or disconnecting the circuit elements connected to the terminals 108a, 108b.

As shown in FIG. 1, the fuse terminals 108a, 108b may be configured to protrude exterior to the fuse interior 112. Moreover, the fuse terminals 108a, 108b may be configured to protrude away from their respective endbells 110a, 110b, e.g., the fuse terminal 108a may be configured to protrude away from the endbell 110a and the fuse terminal 108b may be configured to protrude away from the endbell 110b.

The endbells 110a, 110b may be disposed proximate to the respective fuse body openings 104a, 104b, e.g., the endbell 110a may be disposed proximate to the fuse body opening 104a and the endbell 110b may be disposed proximate to the fuse body opening 104b. The endbells 110a, 110b may be used to seal the fuse interior 112, thereby preventing leakage and/or seepage of the electrical arc quenching substance disposed inside the fuse interior 112. The endbells 110a, 110b may be coupled to the fuse body 102 using one or more pins, screws, nails, welds, and/or in any other desired way.

Each endbells 110a, 110b may include an exterior endbell surface, an interior endbell surface, and an endbell body disposed between the exterior endbell surface and the interior endbell surface. For example, endbell 110a may include an interior endbell surface 114a, an exterior endbell surface 114b, and an endbell body 116a disposed therebetween, and endbell 110b may include an interior endbell surface 118a, an exterior endbell surface 118b, and an endbell body 116b disposed therebetween. Upon coupling of the endbells 110a, 110b to the fuse body 102, the interior endbell surfaces 114a and 118a may be configured to face the fuse interior 112 of the fuse body 102, and the exterior endbell surfaces 114b and 118b may be configured to be face exterior to the fuse interior 112 of the fuse body 102. Moreover, the exterior endbell surfaces 114b and 118b may be configured to be substantially flush with edges of fuse body openings 104a, 104b, respectively.

Upon positioning of the endbells 110a, 110b into the fuse interior 112, outer surfaces of endbell body 122 of endbell bodies may be configured to be placed adjacent (e.g., flush) against fuse body interior surfaces 120 of the fuse body 102 (e.g., as shown with respect to endbell 104b, the fuse body interior surface 120 of the fuse body 102 may be placed adjacent to the outer surface of endbell body 122 of the endbell body 116b). In some implementations, the dimensions of the fuse body interior surface 120 and dimensions of outer surface of endbell body 122 may be substantially the same, smaller and/or larger than one another. This may allow for a friction fit of the endbells 110a, 110b into the fuse body 102. As discussed herein, one or more pins, screws, nails, welds, etc. may be used to secure the endbells 110a, 110b to the fuse body 102.

In some implementations, each endbell 110a, 110b may include respective endbell terminal opening 126a, 126b, e.g., endbell 110a may include endbell terminal opening 126a and endbell 110b may include endbell terminal opening 126b. The endbell terminal openings 126a, 126b may be used for protruding and/or sandwiching the fuse terminals 108a, 108b, respectively, e.g., endbell terminal opening 126a may be used for protruding and/or sandwiching fuse terminal 108a and endbell terminal opening 126b may be used for protruding and/or sandwiching fuse terminal 108b.

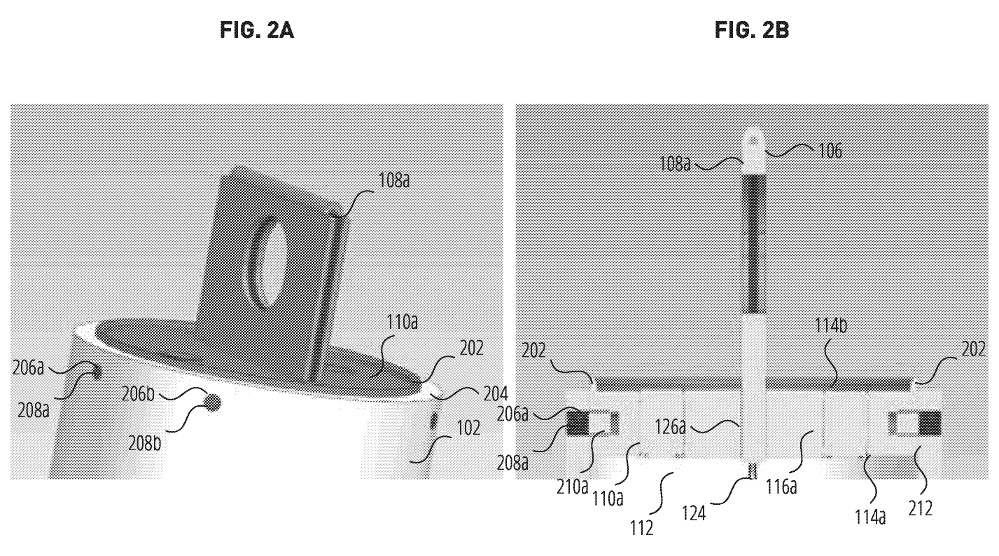

FIGS. 2A-B illustrate further details of the fuse assembly 100 shown in FIG. 1, according to some implementations of the current subject matter. FIG. 2A is a perspective view of a portion of the fuse assembly 100 and FIG. 2B is a side cutout view of the portion of the fuse assembly 100 shown in FIG. 2A. In particular, FIGS. 2A-B illustrate a portion of the fuse body 102 that is coupled to the endbell 110a, where the fuse terminal 108a is configured to extend exterior to the fuse interior 112 and away from exterior endbell surface 114b of the endbell 110a.

As shown in FIGS. 2A-B, the endbell 110a may be configured to be secured to the fuse body 102 using one or more fuse body connector openings 206a, 206b and one or more endbell connector openings 210a, 210b, which may be configured for receiving one or more pins or connectors 208a, 208b. For example, fuse body connector opening 206a, which may be an opening created through the wall of the fuse body 102 may be aligned with endbell connector opening 210a for receiving connector 208a, as, for example, is shown in FIG. 2B. The pin and/or connector 208a may be any type of pin, screw, nail, weld, and/or any other type of connector that may allow securing the endbell 110a to the fuse body 102. Similarly, fuse body connector opening 206b may be aligned with corresponding endbell connector opening for receiving pin and/or connector 208b. Any number of openings in the fuse body 102 along with corresponding endbell connector openings and connectors may be used to secure the endbells to the fuse body 102. As can be understood, endbell 110b may be secured to the fuse body 102 in a similar fashion (not shown in FIGS. 2A-B.

The endbell 110a's exterior endbell surface 114b may include an endbell protrusion 202. The endbell protrusion 202 may be a crushable rib that may be configured to be actuated (e.g., folded, bent, etc.) upon occurrence of an actuation condition, e.g., installation of the endbell 110a into the fuse body 102. The endbell protrusion 202 may be folded, bent, etc. using one or more external tooling, such as, for example, but not limited to, rolling, hammering, pressing, etc.

The endbell protrusion 202 may be configured to be disposed on the exterior endbell surface 114b and configured to extend away from the exterior endbell surface 114b. In some example, non-limiting implementations, the endbell protrusion 202 may be configured to extend substantially perpendicularly to the exterior endbell surface 114b. The endbell protrusion 202 may also extend away from the top surface of the fuse body 204 of the fuse body 102 and without contacting the top surface of the fuse body 204 and/or any other portion of the fuse body 102. Alternatively, or in addition, the endbell protrusion 202 may contact the fuse body 102 upon positioning of the endbell 110a into the fuse body 102.

The endbell protrusion 202 may also be disposed along an entire outer perimeter of the exterior endbell surface 114b, as shown in FIG. 2A. Alternatively, or in addition, the endbell protrusion 202 may be disposed along a portion of the outer perimeter of the exterior endbell surface 114b. Once the actuation condition occurs, the endbell protrusion 202 may be configured to fold, bend, etc. in an outward direction and toward the top surface of the fuse body 204 until the endbell protrusion 202 contacts the top surface of the fuse body 204. Such contact between the top surface of the fuse body 204 and the endbell protrusion 202 may be configured to close and/or cover any gaps 212 that may be created between the fuse body interior surface 120 and outer surface of endbell body 122 when the endbell 110a is positioned into the fuse body 102.

As is also shown in FIG. 2B, the endbell body 116a of the endbell 110a may include an endbell terminal opening 126a. The endbell terminal opening 126a may be configured to allow the fuse element 106 to protrude through endbell terminal opening 126a, thereby exposing fuse terminal 108a for connection to one or more circuit elements (not shown in FIG. 2B). The endbell terminal opening 126a may be sized to ensure that the endbell 110a securely holds the fuse element 106 without any gaps. For instance, the endbell terminal opening 126a may be sealed to prevent leakage and/or seepage of electrical arc quenching substance from the fuse interior 112 of the fuse body 102.

As can be understood, the endbell 110b may include one or more features (e.g., endbell protrusion 202, etc.) that may be similar to the endbell 110a, as discussed in connection with FIGS. 2A-B. Alternatively, or in addition, the endbell 110b may include one or more features that may be different from the endbell 110a.

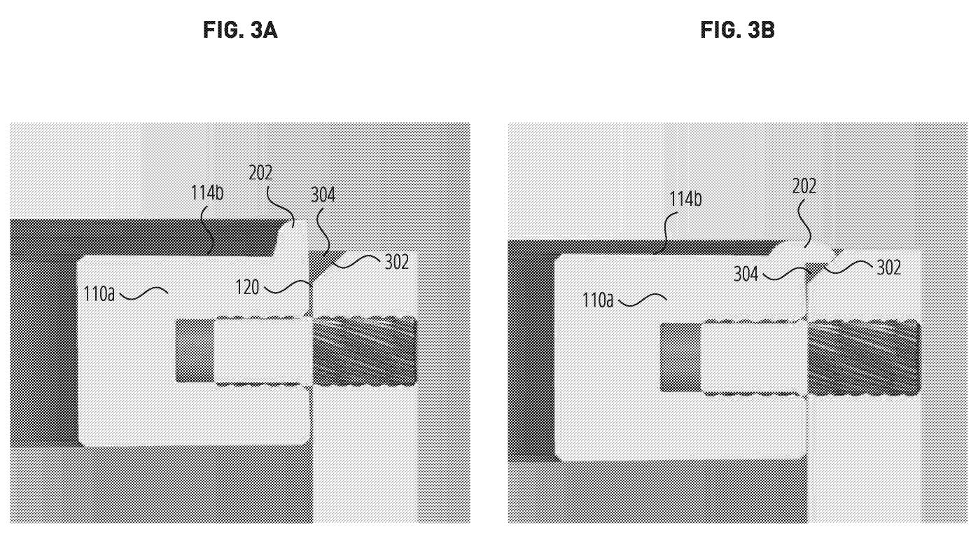

FIGS. 3A-B, illustrate further details the fuse assembly 100, according to some implementations of the current subject matter. FIGS. 3A-B, are cross-sectional view of a portion of the fuse assembly 100 and show a portion of the endbell 110a and a portion of the fuse body 102. In particular, FIG. 3A illustrates the endbell 110a prior to the occurrence of the actuation condition (e.g., installation of the endbell 110a into the fuse body 102) and FIG. 3B illustrates the endbell 110a subsequent to the occurrence of the actuation condition.

As shown in FIGS. 3A-B, the fuse body 102 may include a chamfer 302 that may be positioned on the fuse body interior surface 120. The chamfer 302 may be represented by a slanted edge that may be created and/or present on the fuse body interior surface 120. For instance, the slanted edge may be at a 45-degree angle with respect to the fuse body interior surface 120. As can be understood, any other angular disposition and/or any other shape and/or form of the chamfer 302 may be present. The chamfer 302 may be created during manufacturing process of the fuse body 102 so as to allow for easier installation of the endbell 110a into the fuse body 102. Presence of the chamfer 302 may create a chamfer gap 304. The chamfer 302 may be present throughout the entire fuse body interior surface 120 and/or any one or more portions thereof.

The endbell protrusion 202, upon occurrence of the actuation condition, may be configured to close the chamfer gap 304. Specifically, as shown in FIG. 3B, the endbell protrusion 202 may be configured to fold and/or bend from its initial position (e.g., being substantially vertical to the exterior endbell surface 114b of the endbell 110a, as shown in FIG. 3A) into its closed position (e.g., being substantially parallel to the exterior endbell surface 114b of the endbell 110a, as shown in FIG. 3B). This may allow the endbell protrusion 202 to close the chamfer gap 304, as shown in FIG. 3B. Closure of the chamfer gap 304 by the endbell protrusion 202 may prevent leakage and/or seepage of electrical arc quenching substance from the fuse interior 112 through the gap 212 and/or chamfer gap 304.

As can be understood, similar chamfer may be present at another end of the fuse body 102, where endbell 110b may be coupled to the fuse body 102. The endbell 110b may have similar features (e.g., endbell protrusion 202) to the endbell 110a.

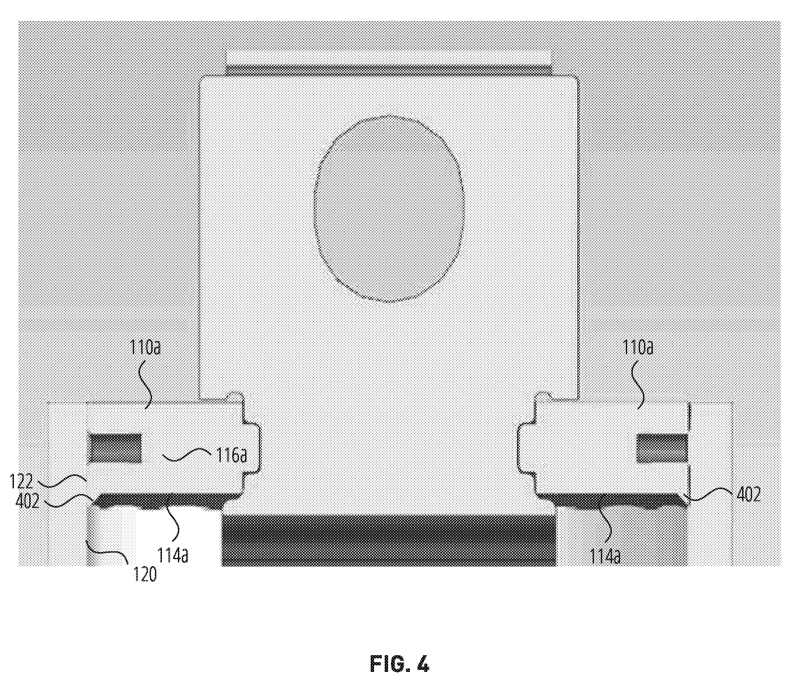

FIG. 4 illustrates further details the fuse assembly 100, according to some implementations of the current subject matter. In particular, the interior endbell surface 114a of the endbell 110a may include an interior protrusion 402 extending away from the interior endbell surface 114a. The interior protrusion 402 may be configured to be disposed along at least a portion of the outer surface of endbell body 122 of the endbell body 116a. The interior protrusion 402 may also be positioned adjacent a fuse body interior surface 120 of the fuse body 102 upon coupling of the fuse body 102 and the endbell 110a.

In some implementations, the interior protrusion 402 may be configured to extend substantially perpendicularly to the interior endbell surface 114a. The interior protrusion 402 may have any desired shape, cross-section, etc. (e.g., as shown in FIG. 4, the interior protrusion 402 may have a triangular cross-section).

Positioning of the interior protrusion 402 adjacent the fuse body interior surface 120, and in particular, substantially flush against the fuse body interior surface 120, may further enhance a seal that may be created upon installation of the endbell 110a into the fuse body 102, thereby preventing leakage and/or seepage of the electrical arc quenching substance from the fuse interior 112. The interior protrusion 402 may be used by itself and/or together with endbell protrusion 202 and/or any other features of the fuse assembly 100 discussed herein.

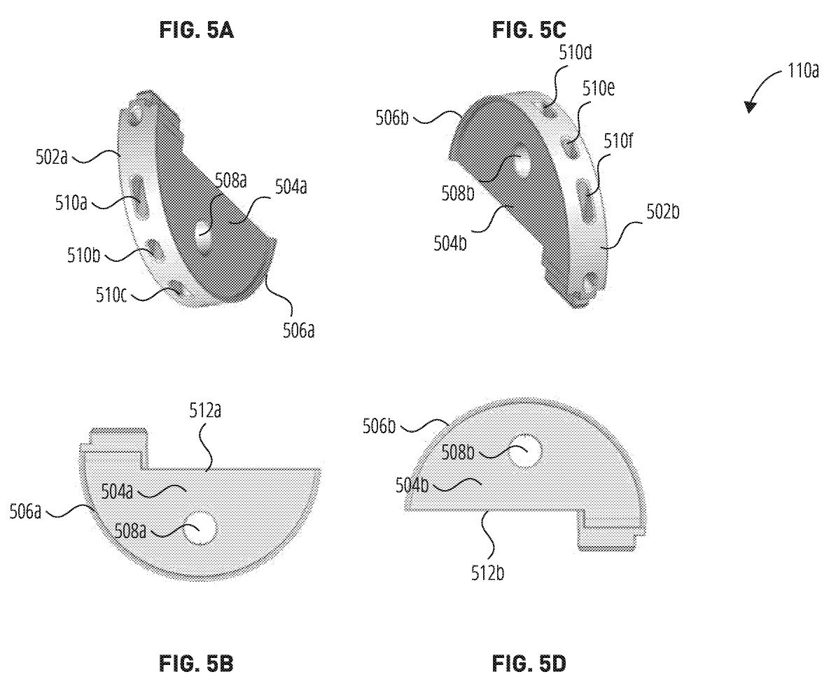

FIGS. 5A-D, illustrate details of the endbell 110a, according to some implementations of the current subject matter. The endbell 110a may be similar to the endbell 110b shown and discussed herein in connection with FIGS. 1-4. FIG. 5A is a perspective view of one portion of the endbell 110a and FIG. 5B is a top view of the portion shown in FIG. 5A. FIG. 5C is a perspective of another portion of the endbell 110a and FIG. 5D is a top view of the portion shown in FIG. 5C.

In some embodiments, the endbell 110a may be a unitary and/or single-piece structure that may include an endbell terminal opening. The fuse element 106 may be slid through the endbell terminal opening of endbell 110a. The fuse terminals (e.g., fuse terminals 108a, 108b as shown in FIG. 1), which may be part of the fuse element and/or coupled to the fuse element, such as, for example, by soldering, welding, etc.

As shown in FIGS. 5A-D, the endbell 110a may include a two-piece endbell design. This may enable the fuse terminals and fuse element to be formed as a single piece, eliminating the manufacturing variability caused by having to separately attach the fuse element between the two terminals. In particular, the endbell 110a may include a first endbell portion 502a and a second endbell portion 502b that may be configured to mate with the first endbell portion 502a. In some implementations, the endbell portions 502a, 502b may be substantially similar and interchangeable with one another. The mating of portions 502a and 502b may be performed prior to installation of the endbell 110a into the fuse body 102 and/or while the endbell 110a is being installed into the fuse body 102.

The first endbell portion 502a may include a first exterior endbell surface 504a and the second endbell portion 502b may include a second exterior endbell surface 504b. Once the first endbell portion 502a and second endbell portion 502b mate, the first exterior endbell surface 504a and the second exterior endbell surface 504b may be configured to form the exterior endbell surface 114b, as shown in FIG. 1. The first endbell portion 502a may include a first protrusion 506a extending away from the first exterior endbell surface 504a and the second endbell portion 502b extending away from the second exterior endbell surface 504b, whereupon mating of the portions 502a and 502b, the combination of the first protrusion 506a and second protrusion 506b may be configured to form the endbell protrusion 202, as shown in FIG. 1.

The first endbell portion 502a may also include a first electrical arc quenching substance fill opening 508a. Similarly, the second endbell portion 502b may include a second electrical arc quenching substance fill opening 508b. The openings 508a, 508b may be through openings and may be used for filling fuse interior 112 (as shown in FIG. 1) with the electrical arc quenching substance. Once the fuse interior 112 is filled with the electrical arc quenching substance, the openings 508a, 508b may be hermetically sealed (e.g., using plugs, welding, etc.).

For installation of the fuse element 106 and/or one or more of its terminals 108a, 108b, each of the first endbell portion 502a and second endbell portion 502b may include respective first fuse element surface 512a and second fuse element surface 512b. Upon mating of the first endbell portion 502a and second endbell portion 502b, the surfaces 512a and 512b may be brought in close proximity to one another while the fuse element 106 and/or one of its terminals 108a, 108b is positioned between (and hence, sandwiched therebetween) the surfaces 512a and 512b. Once the first endbell portion 502a and second endbell portion 502b are mated to one another, the fuse element 106 and/or one of its terminals 108a, 108b is securely attached to the endbell 110a. In some example, non-limiting implementations, the fuse element 106 and/or one of its terminals 108a, 108b may be further secured to the endbell 110a, such as, for example, by welding, glueing, etc. This may provide a seal against leakage and/or seepage of electrical arc quenching substance from the fuse interior 112.

One or more or each of the first endbell portion 502a and second endbell portion 502b may include one or more of one or more endbell connector openings 510 (a, b, c, d, e, f...). The openings 510 (a, b, c, d, e, f...) may be similar to the one or more endbell connector openings 210a. These openings may be used for the purposes of securing the endbell 110a to the fuse body 102. The openings 510 (a, b, c, d, e, f, ...) may have any desired shape and/or size and may be configured to accommodate any type of connectors.

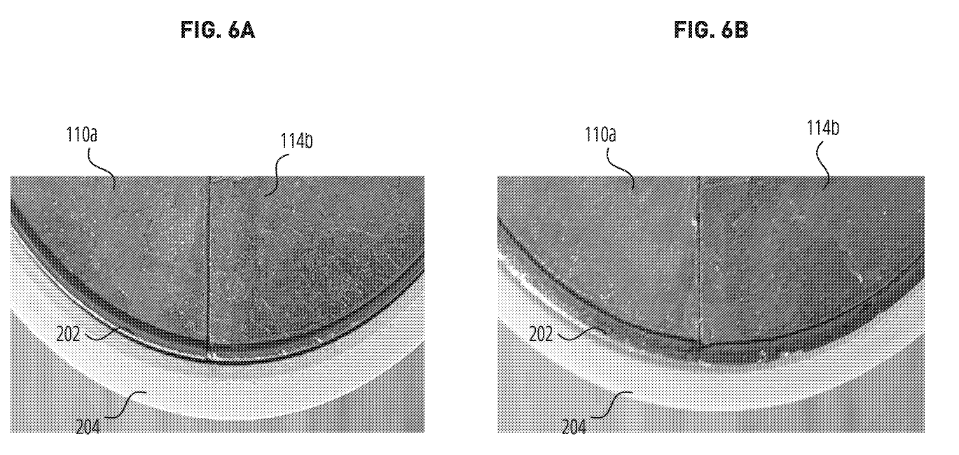

FIGS. 6A-B, illustrate an example of the endbell 110a (and similarly for endbell 110b), according to some implementations of the current subject matter. In particular, FIG. 6A illustrates the endbell 110a prior to actuation condition (e.g., installation of the endbell 110a into the fuse body 102) and FIG. 6B illustrates the endbell 110a subsequent to actuation condition.

As shown in FIG. 6A, prior to the actuation condition, the endbell protrusion 202 may be configured to protrude away from the exterior endbell surface 114b of the endbell 110a. The endbell protrusion 202 does not contact the top surface of the fuse body 204. Once actuation condition occurs, the endbell protrusion 202 may be folded, bent, etc., such as, by rolling, hammering, etc., the endbell protrusion 202, causing the endbell protrusion 202 to fold over and contact the top surface of the fuse body 204, thereby sealing the fuse interior 112 and preventing leakage and/or seepage of the electrical arc quenching substance.

The components and features of the devices described above may be implemented using any combination of discrete circuitry, application specific integrated circuits (ASICs), logic gates and/or single chip architectures. Further, the features of the devices may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

It will be appreciated that the exemplary devices shown in the block diagrams described above may represent one functionally descriptive example of many potential implementations. Accordingly, division, omission or inclusion of block functions depicted in the accompanying figures does not infer that the hardware components, circuits, software and/or elements for implementing these functions would necessarily be divided, omitted, or included in embodiments.

Some embodiments may be described using the expression “one embodiment” or “an embodiment” or “an implementation” or “some implementations” along with their derivatives. These terms mean that a particular feature, structure, or characteristic described in connection with the embodiment is included in at least one embodiment. The appearances of the phrase “in one embodiment” (or derivatives thereof) in various places in the specification are not necessarily all referring to the same embodiment. Moreover, unless otherwise noted the features described above are recognized to be usable together in any combination. Thus, any features discussed separately may be employed in combination with each other unless it is noted that the features are incompatible with each other.

It is emphasized that the abstract of the disclosure is provided to allow a reader to quickly ascertain the nature of the technical disclosure. It is submitted with the understanding that it will not be used to interpret or limit the scope or meaning of the claims. In addition, in the foregoing detailed description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the detailed description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects. Further, the use of “including,” “comprising,” or “having” and variations thereof herein is meant to encompass the items listed thereafter and equivalents thereof as well as additional items. Accordingly, the terms “including,” “comprising,” or “having” and variations thereof are open-ended expressions and can be used interchangeably herein.

For the sake of convenience and clarity, terms such as “top”, “bottom”, “upper”, “lower”, “vertical”, “horizontal”, “lateral”, “transverse”, “radial”, “inner”, “outer”, “left”, and “right” may be used herein to describe the relative placement and orientation of the features and components, each with respect to the geometry and orientation of other features and components appearing in the perspective, exploded perspective, and cross-sectional views provided herein. Said terminology is not intended to be limiting and includes the words specifically mentioned, derivatives therein, and words of similar import.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

In one aspect, a fuse assembly may include a fuse body; a fuse element at least partially disposed within an interior of the fuse body, the fuse element including one or more fuse terminals protruding exterior to the fuse body; and an endbell configured to be coupled to the fuse body, the endbell having an exterior endbell surface and an interior endbell surface, the interior endbell surface being disposed in the interior of the fuse body; the endbell having an actuatable component disposed on the exterior endbell surface and along at least a portion of an outer perimeter of the exterior endbell surface; the actuatable component is configured be actuated upon occurrence of an actuation condition to seal an interior of the fuse body.

The fuse assembly may include wherein the actuatable component includes a protrusion extending from the exterior endbell surface and away from the interior of the fuse body, wherein prior to occurrence of the actuation condition, the protrusion does not contact the fuse body.

The fuse assembly may include wherein, upon occurrence of the actuation condition, the protrusion is configured to fold and contact the fuse body, thereby sealing the interior of the fuse body.

The fuse assembly may include wherein the endbell is a unitary endbell having an endbell terminal opening, the one or more fuse terminals are configured to protrude through the endbell terminal opening.

The fuse assembly may include wherein the endbell includes a first endbell portion and a second endbell portion, the first endbell portion is configured to be coupled to the second endbell portion forming the endbell, wherein the one or more terminals are configured to be coupled to and sandwiched between the first endbell portion and the second endbell portion.

The fuse assembly may include wherein the fuse body includes one or more fuse body openings, wherein the one or more fuse body openings are configured to be aligned with one or more endbell openings, wherein the one or more endbell openings are disposed between the exterior endbell surface and the interior endbell surface, the one or more fuse body openings and the one or more endbell openings are configured to receive one or more pins to secure the endbell to the fuse body.

The fuse assembly may include wherein the interior endbell surface includes an interior protrusion extending away from the interior endbell surface, the interior protrusion is configured to be disposed along at least a portion of an outer perimeter of the interior endbell surface.

The fuse assembly may include wherein the interior protrusion is configured to be positioned adjacent an interior surface of the interior of the fuse body upon coupling of the fuse body and the endbell.

The fuse assembly may include wherein at least a portion of an interior surface of the fuse body includes a chamfer.

The fuse assembly may include wherein, upon occurrence of the actuation condition, the protrusion is configured to fold and cover the chamfer.

The fuse assembly may include wherein the one or more fuse terminals include a first terminal and a second terminal, wherein the first terminal is configured to protrude exterior to a first end of the fuse body and the second terminal is configured to protrude exterior to a second end of the fuse body.

The fuse assembly may include wherein the interior of the fuse body is a hollow interior configured to be filled with an electrical arc quenching substance.

The fuse assembly may include wherein the electrical arc quenching substance includes at least one of the following: a quartz sand, a high-purity silica sand, sand, or any combination thereof, wherein the electrical arc quenching substance is configured to extinguish an electrical arc caused by an overcurrent condition characterized by a current causing a portion of the fuse element disposed between the first and second terminals to melt and generate the electrical arc.

The fuse assembly may include wherein the actuation condition includes coupling of the endbell to the fuse body.

The fuse assembly may include wherein the endbell is formed from a zinc alloy.

In one aspect an endbell for coupling to a fuse body of a fuse, the fuse including a fuse element at least partially disposed within an interior of the fuse body, the fuse element including one or more fuse terminals protruding exterior to the fuse body, may include an endbell body having an exterior endbell surface and an interior endbell surface, the interior endbell surface is configured to be disposed in the interior of the fuse body upon coupling of the endbell and the fuse body; and an actuatable component disposed on the exterior endbell surface and along at least a portion of an outer perimeter of the exterior endbell surface; wherein the actuatable component is configured be actuated upon occurrence of an actuation condition to seal an interior of the fuse body.

The endbell may include wherein the actuatable component includes a protrusion extending from the exterior endbell surface and away from the interior of the fuse body, wherein prior to occurrence of the actuation condition, the protrusion does not contact the fuse body; wherein, upon occurrence of the actuation condition, the protrusion is configured to fold and contact the fuse body, thereby sealing the interior of the fuse body.

The endbell may include wherein the interior endbell surface includes an interior protrusion extending away from the interior endbell surface, the interior protrusion is configured to be disposed along at least a portion of an outer perimeter of the interior endbell surface; wherein the interior protrusion is configured to be positioned adjacent an interior surface of the interior of the fuse body upon coupling of the fuse body and the endbell.

The endbell may include wherein the endbell body is formed from a zinc alloy.

The endbell may include wherein at least a portion of an interior surface of the fuse body includes a chamfer; wherein, upon occurrence of the actuation condition, the protrusion is configured to fold and cover the chamfer.

The foregoing description of example embodiments has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description, but rather by the claims appended hereto. Future filed applications claiming priority to this application may claim the disclosed subject matter in a different manner and may generally include any set of one or more limitations as variously disclosed or otherwise demonstrated herein.

All directional references (e.g., proximal, distal, upper, lower, upward, downward, left, right, lateral, longitudinal, front, back, top, bottom, above, below, vertical, horizontal, radial, axial, clockwise, and counterclockwise) are just used for identification purposes to aid the reader's understanding of the present disclosure, and do not create limitations, particularly as to the position, orientation, or use of this disclosure. Connection references (e.g., attached, coupled, connected, and joined) are to be construed broadly and may include intermediate members between a collection of elements and relative movement between elements unless otherwise indicated. As such, connection references do not necessarily infer that two elements are directly connected and in fixed relation to each other.

Further, identification references (e.g., primary, secondary, first, second, third, fourth, etc.) are not intended to connote importance or priority but are used to distinguish one feature from another. The drawings are for purposes of illustration only and the dimensions, positions, order and relative sizes reflected in the drawings attached hereto may vary.

The present disclosure is not to be limited in scope by the specific implementations described herein. Indeed, other various implementations of and modifications to the present disclosure, in addition to those described herein, will be apparent to those of ordinary skill in the art from the foregoing description and accompanying drawings. Thus, such other implementations and modifications are intended to fall within the scope of the present disclosure. Furthermore, the present disclosure has been described herein in the context of a particular implementation in a particular environment for a particular purpose. Those of ordinary skill in the art will recognize the usefulness is not limited thereto and the present disclosure may be beneficially implemented in any number of environments for any number of purposes. Thus, the claims set forth below are to be construed in view of the full breadth and spirit of the present disclosure as described herein.

What is claimed is:

1. A fuse assembly, comprising:
a fuse body;
a fuse element at least partially disposed within an interior of the fuse body, the fuse element including one or more fuse terminals protruding exterior to the fuse body; and
an endbell configured to be coupled to the fuse body, the endbell having an exterior endbell surface and an interior endbell surface, the interior endbell surface being disposed in the interior of the fuse body;
the endbell having an actuatable component disposed on the exterior endbell surface and along at least a portion of an outer perimeter of the exterior endbell surface;
the actuatable component is configured be actuated upon occurrence of an actuation condition to seal an interior of the fuse body.

2. The fuse assembly of claim 1, wherein the actuatable component includes a protrusion extending from the exterior endbell surface and away from the interior of the fuse body, wherein prior to occurrence of the actuation condition, the protrusion does not contact the fuse body.

3. The fuse assembly of claim 2, wherein, upon occurrence of the actuation condition, the protrusion is configured to fold and contact the fuse body, thereby sealing the interior of the fuse body.

4. The fuse assembly of claim 1, wherein the endbell is a unitary endbell having an endbell terminal opening, the one or more fuse terminals are configured to protrude through the endbell terminal opening.

5. The fuse assembly of claim 1, wherein the endbell includes a first endbell portion and a second endbell portion, the first endbell portion is configured to be coupled to the second endbell portion forming the endbell, wherein the one or more terminals are configured to be coupled to and sandwiched between the first endbell portion and the second endbell portion.

6. The fuse assembly of claim 1, wherein the fuse body includes one or more fuse body openings, wherein the one or more fuse body openings are configured to be aligned with one or more endbell openings, wherein the one or more endbell openings are disposed between the exterior endbell surface and the interior endbell surface, the one or more fuse body openings and the one or more endbell openings are configured to receive one or more pins to secure the endbell to the fuse body.

7. The fuse assembly of claim 1, wherein the interior endbell surface includes an interior protrusion extending away from the interior endbell surface, the interior protrusion is configured to be disposed along at least a portion of an outer perimeter of the interior endbell surface.

8. The fuse assembly of claim 7, wherein the interior protrusion is configured to be positioned adjacent an interior surface of the interior of the fuse body upon coupling of the fuse body and the endbell.

9. The fuse assembly of claim 1, wherein at least a portion of an interior surface of the fuse body includes a chamfer.

10. The fuse assembly of claim 9, wherein, upon occurrence of the actuation condition, the protrusion is configured to fold and cover the chamfer.

11. The fuse assembly of claim 1, wherein the one or more fuse terminals include a first terminal and a second terminal, wherein the first terminal is configured to protrude exterior to a first end of the fuse body and the second terminal is configured to protrude exterior to a second end of the fuse body.

12. The fuse assembly of claim 11, wherein the interior of the fuse body is a hollow interior configured to be filled with an electrical arc quenching substance.

13. The fuse assembly of claim 12, wherein the electrical arc quenching substance includes at least one of the following: a quartz sand, a high-purity silica sand, sand, or any combination thereof, wherein the electrical arc quenching substance is configured to extinguish an electrical arc caused by an overcurrent condition characterized by a current causing a portion of the fuse element disposed between the first and second terminals to melt and generate the electrical arc.

14. The fuse assembly of claim 12, wherein the actuation condition includes coupling of the endbell to the fuse body.

15. The fuse assembly of claim 1, wherein the endbell is formed from a zinc alloy.

16. An endbell for coupling to a fuse body of a fuse, the fuse including a fuse element at least partially disposed within an interior of the fuse body, the fuse element including one or more fuse terminals protruding exterior to the fuse body, the endbell comprising:
an endbell body having an exterior endbell surface and an interior endbell surface, the interior endbell surface is configured to be disposed in the interior of the fuse body upon coupling of the endbell and the fuse body; and
an actuatable component disposed on the exterior endbell surface and along at least a portion of an outer perimeter of the exterior endbell surface;
wherein the actuatable component is configured be actuated upon occurrence of an actuation condition to seal an interior of the fuse body.

17. The endbell of claim 16, wherein the actuatable component includes a protrusion extending from the exterior endbell surface and away from the interior of the fuse body, wherein prior to occurrence of the actuation condition, the protrusion does not contact the fuse body;
wherein, upon occurrence of the actuation condition, the protrusion is configured to fold and contact the fuse body, thereby sealing the interior of the fuse body.

18. The endbell of claim 16, wherein the interior endbell surface includes an interior protrusion extending away from the interior endbell surface, the interior protrusion is configured to be disposed along at least a portion of an outer perimeter of the interior endbell surface;
wherein the interior protrusion is configured to be positioned adjacent an interior surface of the interior of the fuse body upon coupling of the fuse body and the endbell.

19. The endbell of claim 16, wherein the endbell body is formed from a zinc alloy.

20. The endbell of claim 16, wherein at least a portion of an interior surface of the fuse body includes a chamfer;
wherein, upon occurrence of the actuation condition, the protrusion is configured to fold and cover the chamfer.
